(19) United States
(12) Patent Application Publication
(10) Pub. No.: US 2009/0254430 A1
(43) Pub. Date: Oct. 8, 2009

(54) System and method for delivering user-specific streaming video advertising messages

(76) Inventor: Marc Cherenson, Jupiter, FL (US)

Correspondence Address: Cuenot, Forsythe & Kim, LLC, 12230 Forest Hill Blvd., Suite 120, Wellington, FL, 33414, US

(21) Appl. No.: 12/440,609

(22) PCT Filed: Sep. 18, 2007
(86) PCT No.: PCT/US07/78793

§ 371 Date: Mar. 10, 2009

Related U.S. Application Data
(60) Provisional application No. 60/845,354, filed on Sep. 18, 2006.

(51) Int. Cl. G06Q 30/00; G06Q 50/00

(52) U.S. Cl. 705/14.12; 705/14.52; 705/14.66

(57) ABSTRACT

The invention relates to a network-based communications system and method for delivering user-specific streaming video advertising messages to a user. The system provides users free access to interactive streaming video television game shows that deliver advertising messages to the users, while providing demographic profiles of the users to the advertisers. The system includes a computer program running on a server communicatively connected to a communications network (e.g., the Internet), the computer program including instructions for operating the system on a server; a plurality of network access devices each operated by one user of a plurality of users, the plurality of network devices being communicatively connected to the communications network; a streaming video function for delivering advertising messages to the plurality of users; and a database including demographics pertaining to each user of the plurality of users.

### CROSS-REFERENCE

The present application claims the priority of U.S. provisional patent application No. 60/845,354 filed on Sep. 18, 2006.

### FIELD OF THE INVENTION

The invention relates to a network-based communications system and method for delivering user-specific streaming video advertising messages to a user.

### BACKGROUND

Current, Internet-based game shows have a number of disadvantages. As one example, on these game sites, all online players compete in the same game together, which can mean thousands of players competing for a few small prizes. As another example, within a typical Internet-based game, advertising messages are delivered to all players, regardless of player demographics. Thus, the revenue stream for the advertiser is not optimal.

### SUMMARY

The invention relates to a communications network-based system and method for delivering user-specific streaming video advertising messages to a user (also referred to herein as a “player”). The system can be arranged to provide users free access to interactive streaming video television (TV) game shows that deliver advertising messages to the users, while providing demographic profiles of the users to the advertisers. Typically, ten to thirty second audio/video advertisements are delivered over convergence channels such as IPTV (cable), ITV (internet), and wireless (phone), while updatable, user-specific survey data for market analysis of both demographic and product-specific data are collected. The system allows for the compilation of highly detailed user demographics and provides a tool for measuring the effectiveness of specific advertisements or advertising campaigns. The system includes a computer program running on a server communicatively connected to a communications network (e.g., the Internet), the computer program including instructions for operating the system on a server; a plurality of network access devices each operated by one user of a plurality of users, the plurality of network devices being communicatively connected to the communications network; a streaming video function for delivering advertising messages to the plurality of users; and a database including demographics pertaining to each user of the plurality of users.

Accordingly, the invention features a system for delivering user-specific streaming video advertising messages to a user. The system may include a computer program running on a server communicatively connected to a communications network, the computer program further including instructions for operating the system on a server. The system may also include a plurality of network access devices communicatively connected to the communications network and including at least a first device and a second device, wherein the plurality of users, which includes at least a first user and a second user, operates the plurality of network access devices. The system may also include a streaming video function for delivering at least one game show and advertising messages to the plurality of users as well as a database that includes unique demographic information pertaining to at least the first user and the second user.

In another aspect, the invention features the Internet as the communications network.

In another aspect, the invention features the advertising message delivered to at least the first user being customized for the first user based upon the demographic information for the first user contained in the database.

In another aspect, the invention features the demographic information for at least the first user that is contained in the database being collected from the first user through the use of one or more questionnaires that are answered and submitted by the first user through the communications network.

In another aspect, the invention features the plurality of network access devices including at least one device selected from the group consisting of: a cellular telephone, a wireless handheld device, and a wireless gaming device.

The invention also features a method for delivering user-specific streaming video advertising messages to a user. The method includes the steps of: (a) providing multiplayer access to a plurality of games, which includes at least a first game, streamed through a communications network; (b) permitting access by a plurality of users, which includes at least a first user and a second user, to the plurality of games using a plurality of network access devices, which includes at least a first network access device and a second network access device, communicatively connected to the communications network, wherein at least the first user and the second user select at least the first game to play; (c) prior to allowing at least the first user to begin playing the game selected by the first user, delivering at least one questionnaire to the first user to collect demographic information pertaining to the first user; (d) analyzing the demographic information provided by at least the first user to determine marketing interests of the first user; (e) delivering targeted streaming advertisements to at least the first user, wherein the content of the advertisement is determined by the marketing and demographic information associated with the first user; and (f) providing a prize to the user who wins in at least the first game played.

Another method of the invention includes the step of (g) providing direct web links to an advertiser's website within the streaming advertisement delivered to at least the first user.

Another method of the invention includes at least one additional step selected from the group consisting of: (h) delivering an introductory targeted streaming advertisement to at least the first user before the first user begins playing the game; and (i) delivering at least one targeted streaming advertisement to at least the first user during gameplay.

Another method of the invention includes the step of having the plurality of users compete against one another while playing the game.

Another method of the invention includes the step of assigning a rank to at least the first user that changes based upon the number of games won by the first user.

Another method of the invention includes the additional steps of: (k) including a plurality of progressive levels of gameplay in at least the first game; (l) increasing the difficulty at each progressive level of gameplay of at least the first game; (m) increasing the rank of at least the first user as the first user wins in progressively more difficult levels of gameplay; and (n) as the difficulty of each level of gameplay increases, increasing the value of the prize awarded to the winning user.

Another method of the invention includes the step of permitting at least the first user to select to stop playing at any level of gameplay and collect the prize awarded for winning at that level.

Another method of the invention includes the step of permitting at least the first user to select to continue playing the game to attempt to reach the final level of gameplay for an opportunity to win a top prize.

Another method of the invention includes the step of allowing the users who win at top levels of the game to participate in a traditional live-to-tape television game show that is filmed in a television studio.

Another method of the invention includes the step of representing at least the first user on a display screen during the game selected for play by the first user in a manner selected from the group consisting of: a unique user-selected identification moniker, an avatar, a photograph of the user, and live video of the user.

Another method of the invention includes the step of maintaining current demographic information for at least the first user by requiring the first user to provide additional demographic information after completing each progressive level of gameplay of the game before being permitted to progress to the next level of gameplay.

Another method of the invention includes the step of providing free access to the plurality of games to the plurality of users through sponsorship of the games by advertisers.

Another method of the invention includes the step of using a host to guide each game.

Another method of the invention includes the step of selecting the host from at least one of the group consisting of: a computer-generated host, and a live person.

Another method of the invention includes the step of designing the game to prevent the plurality of users from skipping the targeted streaming advertisements.

Unless otherwise defined, all technical terms used herein have the same meaning as commonly understood by one of ordinary skill in the art to which this invention belongs. Although methods and systems similar or equivalent to those described herein can be used in the practice or testing of the present invention, suitable methods and systems are described below. The particular embodiments discussed below are illustrative only and not intended to be limiting.

### DESCRIPTION OF THE DRAWINGS

FIGS. 1-8 are a series of flowcharts illustrating aspects of the invention.

### DETAILED DESCRIPTION

The invention encompasses network-based (e.g., Internet-based) communications systems and methods for delivering user-specific streaming video advertising messages to a user. For example, in one embodiment of the invention, through an Internet site (“the site”), the system can provide interactive streaming video TV game shows in real-time to Internet users (“players”) while delivering user-specific streaming video advertising messages to each player. The site's advertisements can be integrated directly into the game, just like real TV game show prize spots. Generally, access and use of the site is free and available to Internet users who register within the site, provided they qualify to play by completing a demographic profile and comply with any agreements required by the site. When using the system for the first time, typically a user participates in a game show tryout or audition. During this process, the user learns the rules of a particular game, and if the user qualifies to appear on the game show, the system asks the user to complete a ‘contestant application’ form, similar to what is commonly used in TV game show production. A typical application requests demographic information from the user such as age, address, phone, job, schools attended, hobbies, marital and family status, entertainment preferences, etc.

Because each user completes a demographic profile on the site, the system maintains a detailed database of player demographic profiles, prizes and advertiser messages that are custom designed for and delivered to each player individually, even within the same game. Advertisers can collect further customized customer feedback through additional surveys as a component of prize fulfillment. As players win games, they can be directed to a prize fulfillment area where they can complete a survey (or questionnaire). Advertisers who award prizes in games of the system can specify survey information to assist in their own marketing programs. The system thus provides advertisers with the ability to achieve large-scale distribution of low-cost awards for the purpose of developing large, highly detailed customer databases. In a typical embodiment, winning players are asked to complete a different survey at each level of gameplay. The structure and content of the survey is generally determined by the sponsor(s) of the survey and this information can be made available to third parties. Alternatively, the information collected can be made available only to the sponsor(s).

As in the traditional TV game show promotional consideration model, advertisers can receive an appropriate level of exposure for their products and brands in real-time video spots (e.g., ten, fifteen, and thirty second spots) that are integrated into the system. Each advertisement, however, can be specifically targeted to an individual player. As an example, if Ford Motor Company is a game sponsor, the system can be configured to allow Ford to deliver a Ford Focus advertisement to a 22 year old male student player, a Ford Explorer advertisement to a 34 year old female mother player, and a Ford Mustang convertible advertisement to a 56 year old “empty nester” player. All three of these players are competing in the same three-player game, but each player sees a different advertisement for a prize that has been targeted at them individually. In addition, the advertisement(s) can change with each successive game the player wins by analyzing data captured previously. For example, the player can first see an introductory spot, then a succession of advertisements featuring different specific aspects of the prize (e.g., if a car, styling, performance, safety, size, etc.) as indicated by the survey feedback as it is sent to the system over the course of multiple games. Preferably, players cannot skip or fast forward through the advertisements because they stream in real time with no interface to alter them, and if the players are compelled to play the game, they are available to reenter the game as soon as gameplay resumes.

Additionally, in some embodiments, advertisers can receive direct links on the site to their respective corporate Internet sites throughout every game. Players are thus able to click through any advertiser's own Internet site for additional product information, purchases or other services. The system can provide for the promotion of advertiser's brands in the system's off-Internet and on-Internet advertisements and promotions.

In one embodiment, using MPEG4 technology, the system provides exciting real-time TV game show action (music, graphics, live action hosts & announcers, fast-paced gameplay), where players compete head-to-head, in real-time for real prizes and feel as though they are playing in a real, live TV game show. Each prize in a game can be featured in a full motion, streaming video prize spot, just like TV game show prizes. Typically, game players are grouped into separate two, three or four player contests, and in every two, three, or four player game, there is a prize winner. In a typical embodiment, on the Internet site, games are starting all of the time, and there are hundreds of winners. Players are initially awarded prizes such as mass-distribution, money-saving coupons, rebates, and low-cost promotional merchandise. As players move up in ranking, e.g., by winning multiple consecutive games or multiple progressive levels of one game, they may be able to win valuable products and services including grand prizes such as cars, vacations, and large cash awards. The system features a progressive game cycle, such that a user who wins at a first level is entitled to play at the second level, and so on. As already mentioned, as a successful player plays through each level, the prizes can increase in value. Players can thus elect to stop playing at any level and are awarded the appropriate prize for that level. Alternatively, a player can “turn in” his or her prize and continue to play, in an attempt to reach the final round of gameplay to compete against two other players for the top prize.

The system can be configured to provide games for all age groups, tastes, and skill levels, including popular trivia games, fun entertainment games, and brain teasing word games. Each game is designed to give the player pulse-pounding TV game show action, and the excitement of winning great prizes. New games can be added regularly, so players will be back, time and again, for more TV game show fun.

By including a detailed player profile database, the system can deliver an audited, targeted audience to advertisers who are thus able to expose their brands and products to the exact demographic groups they need to reach. The result is that within a game, irrespective of each player's demographic make-up, every player will be exposed to individually specified advertising messages, and compete for individually specified prizes. Each game can be designed to attract a specific set of demographic segments with content and game formats (e.g., music, trivia, movies, etc.) designed accordingly.

In various embodiments of the invention, the system can provide for one or more sponsors (advertisers) for a particular game. A sponsor can choose to be a game's only sponsor. Games can have geographically regional or national sponsors, specific time slot sponsors, or any combination thereof. As an example, after one game level of a sports game series, if a primary sponsor such as Home Depot and affiliated sponsors know that player A is a 32 year old salesman and new father who recently relocated to a condo in a 15 year old building in Tampa, Fla., the sponsor (Home Depot) can target player A with advertisements for home improvement (e.g., Sherwin-Williams paint, Disney Home floor and wall coverings, contractor services, GE appliances, etc.). Similarly, if the sponsors know that player B is a 58 year old manager who enjoys woodworking as a hobby and owns a home, the sponsors can target player B with advertisements for Black & Decker power tools, hardware, Ortho lawn care, Coleman patio/pool furniture, etc. If player C is a new college student living off campus, the sponsors can target this player with advertisements for particular brands of furniture, small appliances, area rugs, etc. In this example, prizes for any of the three players could be redeemable at the local Home Depot location, thereby placing the individual in the store for greater exposure to the brands and possible additional purchases. This example represents one single game out of thousands of games that are taking place during the course of this one particular sports game series, which can extend to multiple (e.g., 2, 3, 4, 5, 6, 7, 8, 9, 10, 11, 12, 13, 14, 15, or more) ascending game levels.

The system can make available to the general audience (e.g., as a promotional enhancement), through separate delivery channels, linear versions of live and replay episodes of top-level games, where the best prizes are awarded (e.g., cars, lavish trips, kitchen remodeling, etc.). In some embodiments, top-level players can be brought into a TV studio for filming traditional, live-to-tape TV shows. Such non-interactive broadcasts allow for a mass audience to be introduced to the excitement and pay-offs provided by the system, and can create additional exposure for sponsors.

In a typical embodiment, a game host that appears to interact directly with the players guides the gameplay and enhances the experience of being in a live TV game show. Preferably, a game host enhances the dynamic of the game by increasing the excitement and immediacy of the game, as well as by providing fun and humor. A host can come from the same arena as a particular game's content. For example, a sports themed game can be hosted by a well known sports personality. In another example, a TV cartoon game can be hosted by a popular cartoon figure.

Any suitable technologies can be used in the invention to deliver real-time, interactive streaming audio/video content with a specially designed graphic format that emulates the traditional TV game show look, feel and sound (e.g., colorful sets, dramatic lighting, bold graphics and effects, proprietary sound effects and music, audience ambience, active player controls, host interaction, etc.). An example of such a technology is the remote control of 3D avatars appearing on a player's hardware.

The invention also encompasses a method for obtaining demographic information about a plurality of users that can be analyzed to provided targeted streaming advertisements to the plurality of users. Streaming advertisements are delivered to each player based upon computer analysis of the user's likely marketing preferences as determined by the user-defined demographic information.

In one step of the method, multiplayer access to a plurality of games streamed through a communications network is provided. In an exemplary embodiment of the method, a plurality of users are permitted free access to the plurality of games. In other embodiments, the plurality of users may pay a one-time fee or subscription fees to access the plurality of games on the communications network. Each user is allowed to select one game of the plurality of games to play.

In another step of the method, at least one questionnaire is delivered to each of the plurality of users to collect demographic information pertaining to each user prior to each user beginning the game. The demographic information provided by each user is analyzed, typically by a computer, to determine the marketing interests and preferences of each user. Based upon the user's marketing interests and preferences as determined by analysis of the user's demographic information, targeted streaming advertisements are delivered to each of the plurality of users. The content of the advertisement is determined by the unique marketing and demographic information associated with each user. In an exemplary embodiment, users may compete against one another while playing the game. A prize is provided to the user who wins in each game played.

Targeted streaming advertisements can be delivered to users at any of several times. For example, an introductory targeted streaming advertisement can be delivered to each user before the user begins playing the game. In another embodiment, at least one targeted streaming advertisement can be delivered to each user during gameplay. In another embodiment, a targeted streaming advertisement can be delivered to the associate after gameplay ends. In one step of the method, direct web links to an advertiser's website can be provided within the streaming advertisement delivered to each user. The demographic information for each user can be kept current by requiring the user to provide additional demographic information after completing each level of gameplay of the game before being permitted to progress to the next level of gameplay. Free access to the plurality of games can be provided to the users through sponsorship of the games by advertisers. In an exemplary embodiment of the method, the game does not permit the plurality of users to skip the targeted streaming advertisements.

In embodiments where gameplay progresses through increasingly difficult levels of the game, each user can be assigned a rank that changes based upon the number of games won by the user. The difficulty at each progressive level of gameplay of the game increases while the rank assigned to the user also increases as the user wins in progressively more difficult levels of gameplay. The value of the prizes awarded to the winning user of each game may also increase as the difficulty of each level of gameplay increases.

Users can choose to stop playing at any level of gameplay and collect the prize awarded for winning at that level. However, in an exemplary embodiment, the user can choose to continue playing the game to attempt to reach the final level of gameplay for an opportunity to win the top (or most valuable) prize. In another embodiment, users who win at top levels of the game may be allowed to participate in a traditional live-to-tape television game show that is filmed in a television studio. This live-to-tape television game show can then be aired on one or more of the communications network, free-access television, and cable television.

Users can be represented on a display screen on the user's network access device during the game by a unique user-selected identification moniker, an avatar, a photograph of the user, or by live video of the user.

In another step of the method, a host may guide each game. The host can be selected from a computer-generated host or a live person.

### Example

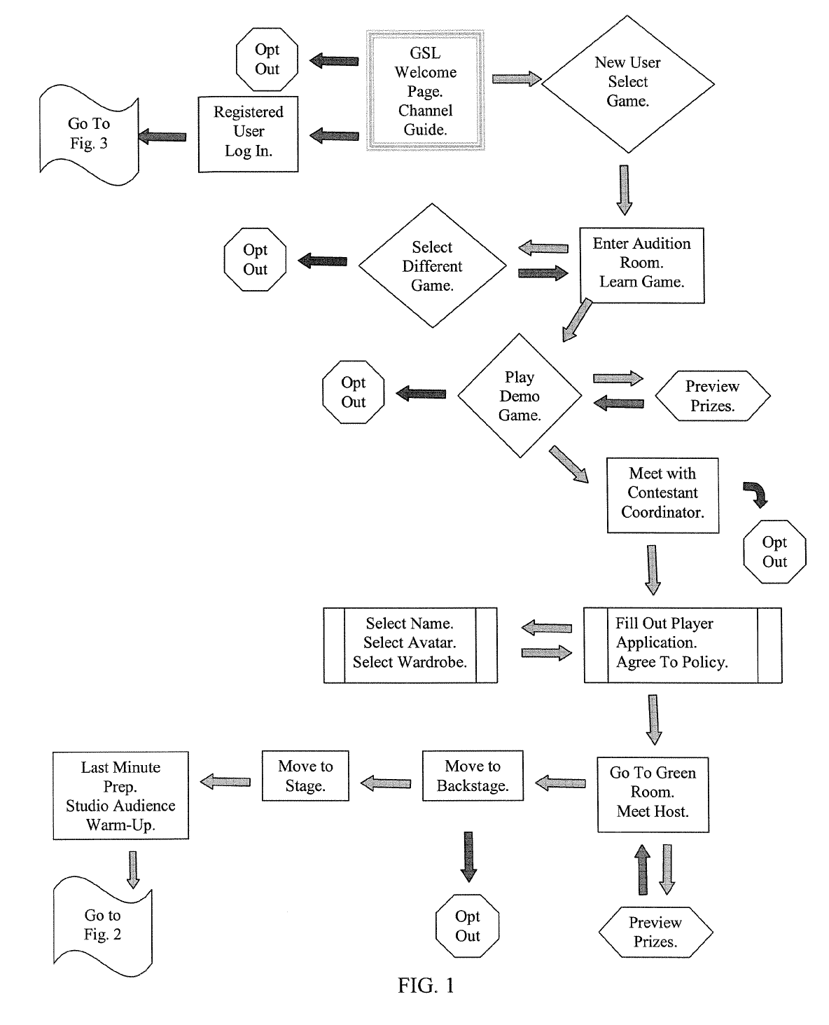

Referring now to the drawings, in FIG. 1, a new user logs into the system and selects a game to play. If desired, the user may elect to play a demo game, preview the prizes for winning the game, and/or meet with a contestant coordinator. The user can be required to complete and application and to agree to the policies of the system's provider. The user may select a user name, an avatar, and/or the avatar's wardrobe. The user can then meet the host and move to the virtual stage. The user can optionally move to a backstage area of the game prior to beginning gameplay.

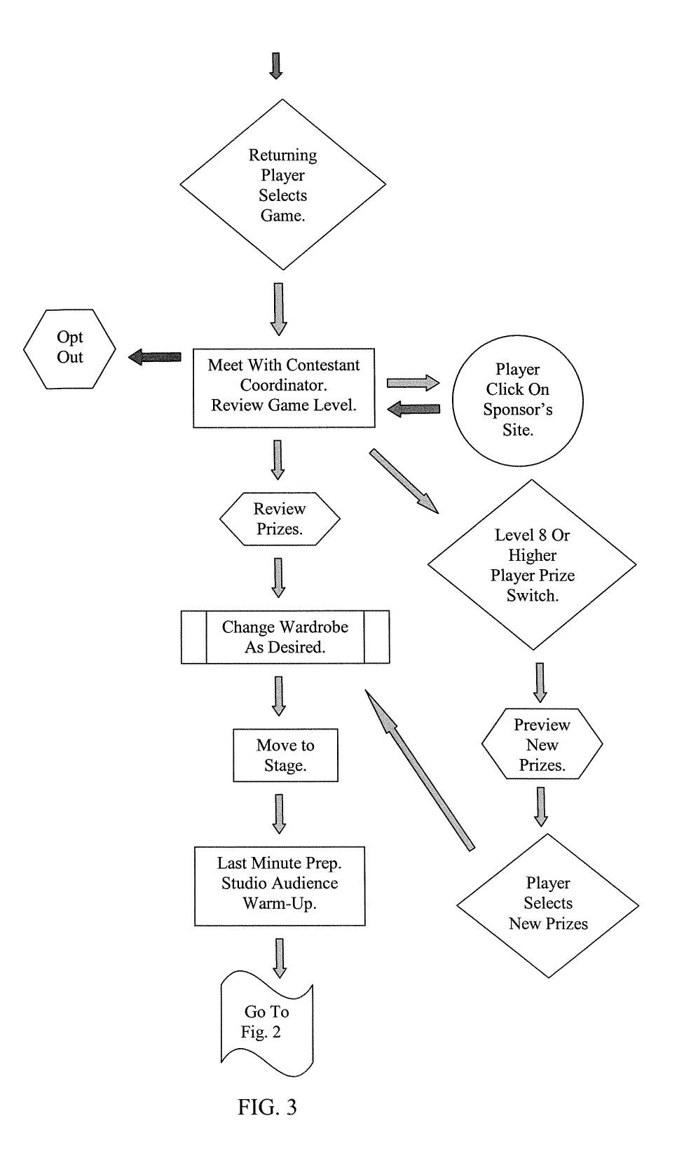

As shown in FIG. 3, a returning user can select a game and may elect to meet with the contestant coordinator and review the game level. The returning user may also visit a sponsor's website, review prizes, and change the avatar's wardrobe. The returning user may also be permitted switch prizes, preview new prizes, and select new prizes.

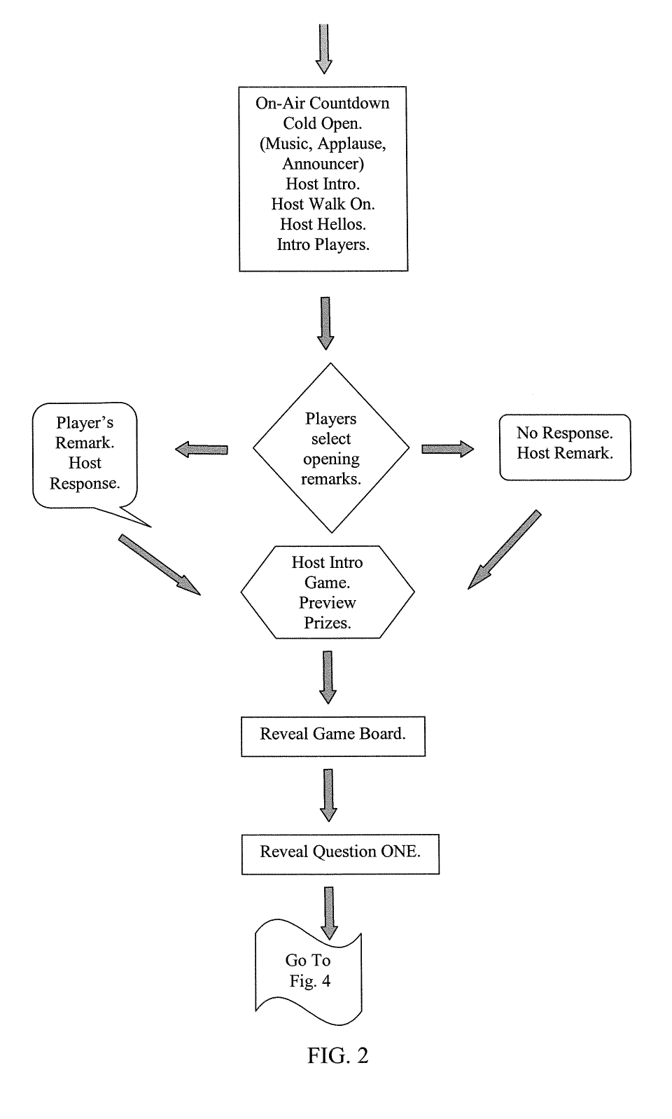

In FIG. 2, an on-air countdown can be conducted and, thereafter, the host and players (users) can be introduced to an audience. Both the host and the users can be permitted to provide opening remarks and responses to comments made by each other. The host may introduce the game and describe or preview the prizes. The host then may reveal the game board and the first question to the users.

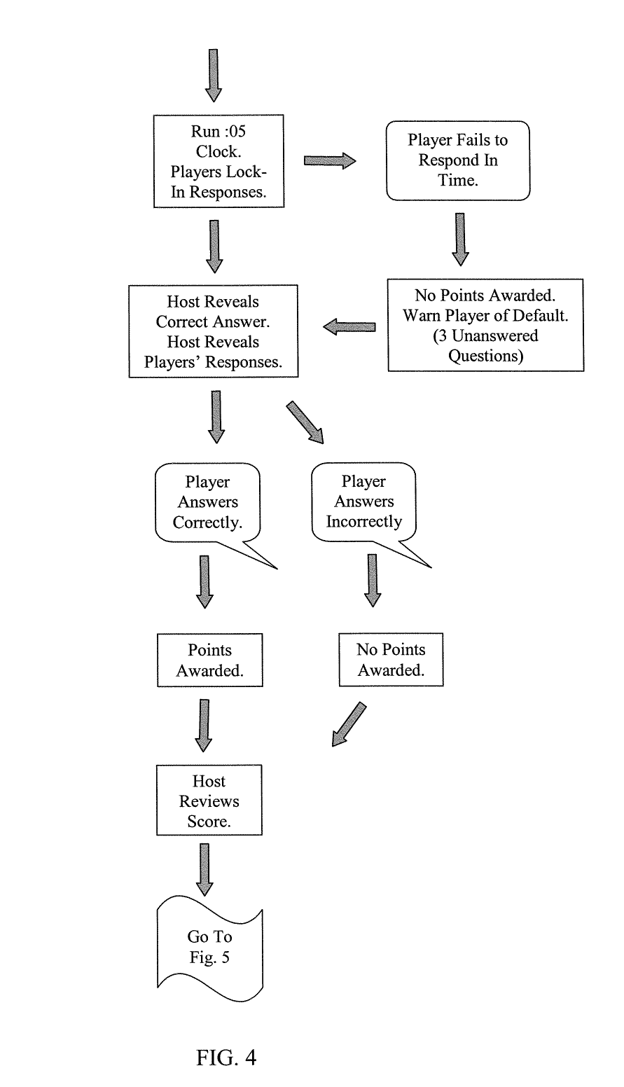

In FIG. 4, the users enter their responses into the system. If a user fails to respond in the allotted time, no points are awarded. The user may be warned of a default (disqualification from the game) if the user fails to respond more on than about three (e.g., 1, 2, 3, 4, 5, 6, 7, 8, or more) occasions. Disqualified users are removed from the game and may be permitted to select a new game to begin playing or to exit the system.

If the user answers the first question correctly, points may be awarded to the user. The host may periodically review the users' scores.

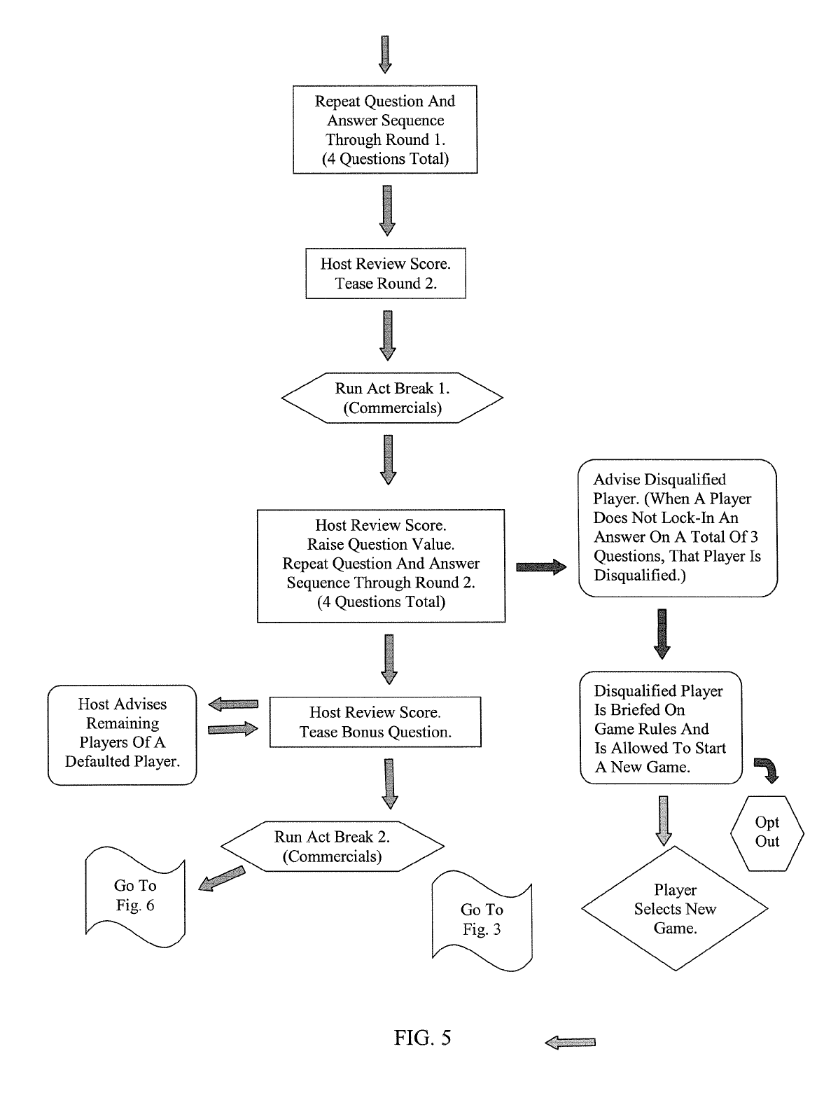

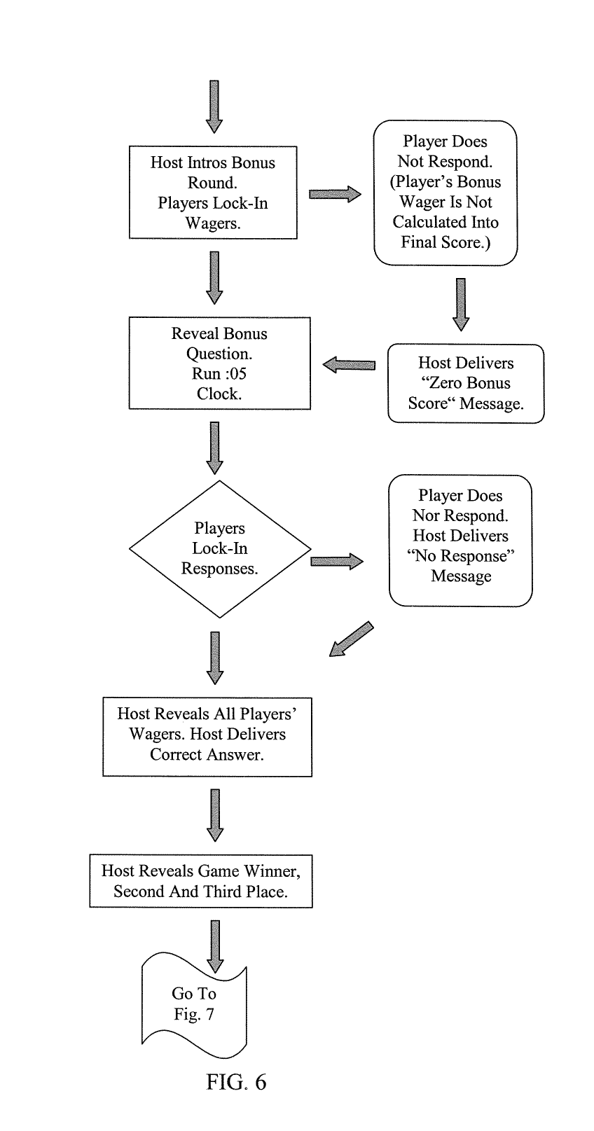

In FIG. 5, the question-and-answer sequence may be repeated by the host and users several (e.g., 1, 2, 3, 4, 5, 6, 7, 8, 9, 10, or more) times during at least a first level or round of the game. The game may include a “tease” round, a bonus round as shown in FIG. 6, and/or commercials by the game's sponsors (advertisers). The game can include multiple (e.g., 1, 2, 3, 4, 5, 6, 7, 8, or more) rounds.

In FIG. 6, the host may reveal all users' wagers and can deliver the correct answer to the game question. The host may also identify the game winner and the positions of the runners-up, e.g., second place user, third player user, etc.

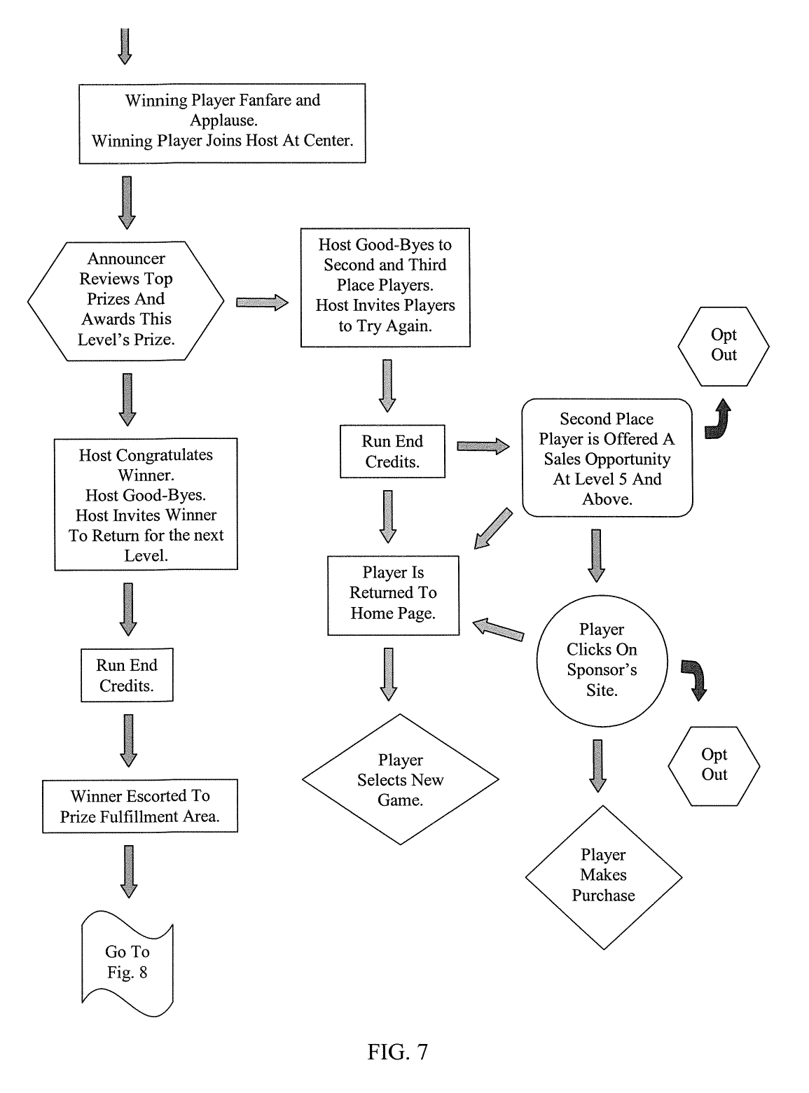

In FIG. 7, an announcer reviews the prizes, including any top prizes, and awards the immediate level's prize to the winning user. The host may congratulate the winner and can invite the losing users to play again. After end credits are displayed on the display screen of the network access device used by each user, each user is returned to the home page of the game system where the user may visit the game sponsors' websites. the winning user can be directed to a prize fulfillment area of the system.

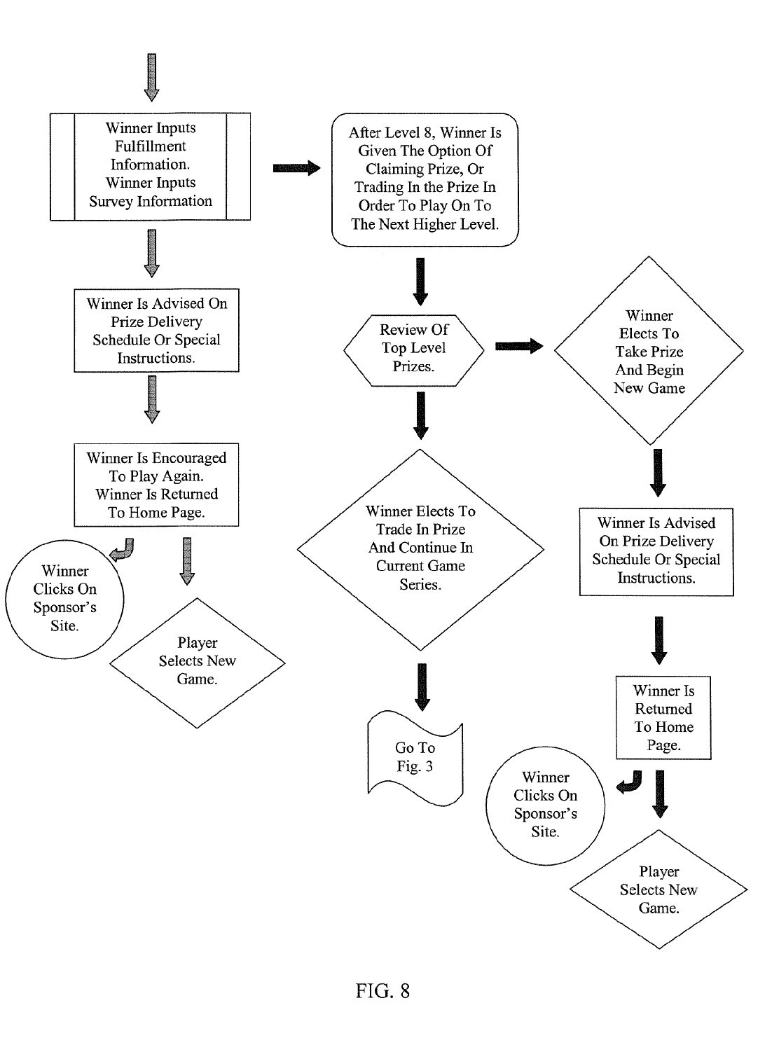

In FIG. 8, the winning user provides responses to a survey or questionnaire which may request demographic information about the user. The winning user is advised about prize delivery schedule or special schedule instructions and the user is encouraged to play again. The winning user may then be directed to the home page of the system where the user may visit the game sponsors' websites. The user may also select to play a new game from the home page.

After reaching a predetermined progressive level of the game, the winning user may be permitted to forgo the option of claiming a prize for a particular level to proceed in playing the game for an opportunity to win a top level prize in a higher level of the game.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for delivering user-specific streaming video advertising messages to a user, the system comprising:
a computer program running on a server communicatively connected to a communications network, the computer program comprising instructions for operating the system on a server;
a plurality of network access devices communicatively connected to the communications network and comprising at least a first device and a second device, wherein the plurality of users, which comprises at least a first user and a second user, operates the plurality of network access devices;
a streaming video function for delivering at least one game show and advertising messages to the plurality of users; and
a database comprising unique demographic information pertaining to at least the first user and the second user.

2. The system of claim 1, wherein the communications network is the Internet.

3. The system of claim 1, wherein the advertising message delivered to at least the first user is customized for the first user based upon the demographic information for the first user contained in the database.

4. The system of claim 3, wherein the demographic information for at least the first user that is contained in the database is collected from the first user through the use of one or more questionnaires that are answered and submitted by the first user through the communications network.

5. The system of claim 1, wherein the plurality of network access devices comprise at least one device selected from the group consisting of: a cellular telephone, a wireless handheld device, and a wireless gaming device.

6. A method comprising the steps of:
(a) providing multiplayer access to a plurality of games, which comprises at least a first game, streamed through a communications network;
(b) permitting access by a plurality of users, which comprises at least a first user and a second user, to the plurality of games using a plurality of network access devices, which comprises at least a first network access device and a second network access device, communicatively connected to the communications network, wherein at least the first user and the second user select at least the first game to play;
(c) prior to allowing at least the first user to begin playing the game selected by the first user, delivering at least one questionnaire to the first user to collect demographic information pertaining to the first user;
(d) analyzing the demographic information provided by at least the first user to determine marketing interests of the first user;
(e) delivering targeted streaming advertisements to at least the first user, wherein the content of the advertisement is determined by the marketing and demographic information associated with the first user; and
(f) providing a prize to the user who wins in at least the first game played.

7. The system of claim 6, wherein the method comprises the additional step of:
(g) providing direct web links to an advertiser's website within the streaming advertisement delivered to at least the first user.

8. The system of claim 6, wherein the method comprises at least one additional step selected from the group consisting of:
(h) delivering an introductory targeted streaming advertisement to at least the first user before the first user begins playing the game; and
(i) delivering at least one targeted streaming advertisement to at least the first user during gameplay.

9. The method of claim 6, wherein the plurality of users compete against one another while playing the game.

10. The method of claim 6, wherein the method comprises the additional step of:
(j) at least the first user is assigned a rank that changes based upon the number of games won by the first user.

11. The method of claim 10, wherein the method comprises the additional steps of:
(k) at least the first game includes a plurality of progressive levels of gameplay;
(l) increasing the difficulty at each progressive level of gameplay of at least the first game;
(m) increasing the rank of at least the first user as the first user wins in progressively more difficult levels of gameplay; and
(n) as the difficulty of each level of gameplay increases, increasing the value of the prize awarded to the winning user.

12. The method of claim 11, wherein at least the first user can choose to stop playing at any level of gameplay and collect the prize awarded for winning at that level.

13. The method of claim 11, wherein at least the first user can choose to continue playing the game to attempt to reach the final level of gameplay for an opportunity to win a top prize.

14. The method of claim 11, wherein the users who win at top levels of the game are allowed to participate in a traditional live-to-tape television game show that is filmed in a television studio.

15. The method of claim 6, wherein at least the first user is represented on a display screen during the game selected for play by the first user in a manner selected from the group consisting of: a unique user-selected identification moniker, an avatar, a photograph of the user, and live video of the user.

16. The method of claim 6, wherein the demographic information for at least the first user is kept current by requiring the first user to provide additional demographic information after completing each progressive level of gameplay of the game before being permitted to progress to the next level of gameplay.

17. The method of claim 6, wherein free access to the plurality of games is provided to the plurality of users through sponsorship of the games by advertisers.

18. The method of claim 6, wherein a host guides each game.

19. The method of claim 18, wherein the host is selected from at least one of the group consisting of: a computer-generated host, and a live person.

20. The method of claim 6, wherein the game does not permit the plurality of users to skip the targeted streaming advertisements.
